(19) United States
(12) Patent Application Publication
(10) Pub. No.: US 2025/0190919 A1
(43) Pub. Date: Jun. 12, 2025

(54) SYSTEM AND METHOD FOR ARTIFICIAL INTELLIGENCE (AI) ASSISTED ACTIVITY TRAINING

(71) Applicant: RAJIV TREHAN, BANGKOK (TH)

(72) Inventor: RAJIV TREHAN, BANGKOK (TH)

(21) Appl. No.: 19/045,621

(22) Filed: Feb. 5, 2025

Related U.S. Application Data
(63) Continuation-in-part of application No. 17/721,395, filed on Apr. 15, 2022, now Pat. No. 12,246,241.

(51) Int. Cl. G06Q 10/0639; G06F 9/451; G06V 40/20

(52) U.S. Cl. CPC G06Q 10/06393; G06F 9/451; G06V 40/23

(57) ABSTRACT

The disclosure relates to system and method for monitoring user activities. A plurality of users are selected based on first grouping criteria. An activity challenge is generated associated with at least one activity and a set of Key Performance Indicators (KPIs). A plurality of subsets of users from the set of users are created in response to an input received from the set of users based on at least one of attributes of each of the set of users, and the set of KPIs associated with the activity challenge. Performance parameters of each user are compared with at least one of the set of KPIs by the AI model. An interactive leader board is rendered indicating performance of each user relative to the remaining users in an associated subset of users and a first subset from the plurality of subsets of users relative to remaining subsets of users.

### CROSS-REFERENCE TO RELATED APPLICATION

This application claims priority benefits of and is a continuation-in-part of co-pending U.S. application Ser. No. 17/721,395 filed on Apr. 15, 2022, which is hereby expressly incorporated by reference in its entirety for all purposes.

### TECHNICAL FIELD

This disclosure relates generally to system and method for monitoring activities, and more particularly to system and method for monitoring activities using Artificial Intelligence (AI) models.

### BACKGROUND

Health has been a priority for many. Over the last couple of years, people have been increasingly aspiring to be healthy and have normal levels of fitness, while maintaining work and personal life balance. Moreover, desire to manage their own health has been increasing. As a result, exercising after work, while travelling, on weekends, or in free time, has been on the rise. There are a variety of physical activities (for example, strength training, dance, yoga, Pilates, martial arts, boxing, meditation, physical therapy and rehabilitation, CrossFit, Les Mills, F45, Zumba, Bikram Yoga, Orange Theory, or other types of workouts or exercises) that may be performed to improve quality of life with a little investment of time. Moreover, there are a lot of facilities and provisions that facilitate user's access to such variety of physical activities. Notwithstanding, many people do not want to travel and visit exercise facilities, gyms, physical rehabilitation centers, dojos, martial arts centers, dance studios as they do not have time and/or motivation. Other reasons may be affordability, as some people may not be able to afford personal instructions provided by trained experts. Due to pandemics like COVID, people have become conscious about visiting such facilities because of potential virus and communicative illnesses. Physical disabilities may be another factor that may discourage people from travelling to and using such facilities.

As a result of the aforementioned issues, many people have started exercising or performing other activities in the comfort of their home or room (for example, hotel room). Indoor performance of physical activities has been resonating with many people, since a person's schedule, weather, or other limiting factors as mentioned above can be easily circumvented. Accordingly, sale of indoor exercise apparatuses, such as treadmills, stair exerciser apparatuses, steppers, exercise bikes, elastic bands, and other similar motion exerciser apparatuses has increased.

For best results of such physical activities and to reduce the chance of muscle damage and injuries, many such physical activities require a user to correctly perform complex actions entailed therein. Additionally, skilled adjustment of weights or force resistance may also be of importance. Thus, unless the user has an expert to analyze the pose and movements of the user, the user may perform one or more actions with improper pose and movements, thereby injuring himself. Moreover, in the long run, performing such physical activities indoors may get mundane and boring, as trainers or peers are not present to motivate or encourage the user to keep performing. As a result, the user may get discouraged and may either become irregular or may completely stop performing any physical activity. It is a challenge for many to consistently follow a fitness regimen in their pursuit of health and fitness.

Therefore, there is a need for methods and systems that assist users in performing physical activities indoors under expert guidance and monitor user activities to keep them motivated, while being convenient and cost effective.

### SUMMARY

In an embodiment, a method of monitoring user activities is disclosed. The method may include selecting a plurality of users based on a first grouping criteria. The method may further include generating an activity challenge. In an example, the activity challenge is associated with at least one activity and a set of Key Performance Indicators (KPIs). The method may further include creating, via an Artificial Intelligence (AI) model, a plurality of subsets of users from the set of users in response to the input received from the set of users. It may be noted that the plurality of subsets of users may be created based on at least one of: attributes of each of the set of users, and the set of KPIs associated with the activity challenge. The method may further include analyzing, by the AI model, the at least one activity performed by each user in the plurality of subsets of users to determine performance parameters of each user in the plurality of subsets of users, in response to initiation of the activity challenge by an associated user. Further, the method may include comparing, by the AI model, the performance parameters of each user in the plurality of subsets of users with at least one of the set of KPIs. Furthermore, the method may include rendering, via a graphic user interface (GUI), based on a result of the comparing and at least one of the set of KPIs, an interactive leader board indicating performance of at least one of: each user relative to the remaining users in an associated subset of users from the plurality of subsets of users; and a first subset of users from the plurality of subsets of users relative to a remaining plurality of subsets of users.

In another embodiment, a system for monitoring user activities is disclosed. The system may include a processor, and a memory communicatively coupled to the processor. The memory may include processor-executable instructions, which when executed by the processor may cause the processor to select a plurality of users based on a first grouping criteria. The processor-executable instructions may further cause the processor to generate an activity challenge. The activity challenge may be associated with at least one activity and a set of Key Performance Indicators (KPIs). The processor-executable instructions may further cause the processor to receive from a set of users in the plurality of users an input corresponding to acceptance of the activity challenge via a Graphical User Interface (GUI) of an associated device. The processor-executable instructions may further cause the processor to create, via an Artificial Intelligence (AI) model, a plurality of subsets of users from the set of users in response to the input received from the set of users. It may be noted that the plurality of subsets of users may be created based on at least one of: attributes of each of the set of users, and the set of KPIs associated with the activity challenge. The processor-executable instructions may further cause the processor to analyze, by the AI model, the at least one activity performed by each user in the plurality of subsets of users to determine performance parameters of each user in the plurality of subsets of users, in response to initiation of the activity challenge by an associated user. The processor-executable instructions may further cause the processor to compare, by the AI model, the performance parameters of each user in the plurality of subsets of users with at least one of the set of KPIs. The processor-executable instructions may further cause the processor to render, via a graphic user interface (GUI), based on a result of the comparing and at least one of the set of KPIs, an interactive leader board indicating performance of at least one of: each user relative to the remaining users in an associated subset of users from the plurality of subsets of users and a first subset of users from the plurality of subsets of users relative to a remaining plurality of subsets of users.

In yet another embodiment, a device for monitoring user activities is disclosed. The device may include a processor, a Graphical User Interface (GUI) and a memory. The memory may be communicatively coupled to the processor. The memory may store processor-executable instructions, which, on execution, may cause the processor to receive an input from a user corresponding to acceptance of an activity challenge via the GUI. The activity challenge may be associated with at least one activity and a set of Key Performance Indicators (KPIs). In an example, based on the input a user associated to the device may be added to at least one of a plurality of subsets of users from a set of users based on: attributes of each of the set of users, and the set of KPIs associated with the activity challenge. Further, the processor-executable instructions, which, on execution, may cause the processor to determine performance parameters of the user based on analysis of the at least one activity performed by the user and remaining users in an associated subset of users from the plurality of subsets of users in response to initiation of the activity challenge by the user and the remaining users. Further, the processor-executable instructions, which, on execution, may cause the processor to render on the GUI, an interactive leader board indicating performance of at least one of: the user relative to the remaining users in the associated subset of users from the plurality of subsets of users, and a first subset of users to which the user is associated from the plurality of subsets of users relative to a remaining plurality of subsets of users. In an example, the interactive leader board may be rendered based on a result of comparison of performance parameters each user in the plurality of subsets of users with at least one of the set of KPIs.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of a system for monitoring user activities, in accordance with some embodiments.

FIG. 2 illustrates a functional block diagram of the activity monitoring device and the user-device, in accordance with an embodiment of the disclosure.

FIGS. 3A and 3B illustrate exemplary GUIs for generating an activity challenge, in accordance with some embodiments.

FIG. 4A illustrates an exemplary GUI for generating an activity challenge, in accordance with some embodiments of the present disclosure.

FIG. 4B illustrates an exemplary GUI rendered for defining KPIs of an activity challenge is illustrated, in accordance with some embodiments of the present disclosure.

FIG. 4C illustrates a reward reference table, in accordance with an embodiment of the present disclosure.

FIG. 5A illustrates an exemplary GUI rendered on a user-device listing a list of activity challenges, in accordance with some exemplary embodiments.

FIG. 5B illustrates an exemplary GUI rendered on a user-device when an activity challenge is selected in order to be accepted is illustrated, in accordance with some embodiments of the present disclosure.

FIG. 5C illustrates an exemplary GUI displaying an error notification, in accordance with an embodiment of the present disclosure.

FIG. 5D illustrates an exemplary GUI rendered on a user device to provide an acceptance of an activity challenge, in accordance with an embodiment of the present disclosure.

FIG. 5E illustrates an exemplary GUI rendered on a user-device for initiating an activity challenge, in accordance with some embodiments of the present disclosure.

FIG. 6 illustrates an exemplary GUI indicating the performance parameters determined by the activity performance analysing module of the activity monitoring device, in accordance with an embodiment of the present disclosure.

FIG. 7 illustrates an exemplary GUIs indicating a performance report of a user is illustrated, in accordance with an embodiment of the present disclosure.

FIG. 8A illustrates an exemplary GUI rendering an interactive leadership board rendering performance parameters of a set of users associated with an activity challenge, in accordance with an embodiment of the present disclosure.

FIG. 8B illustrates an exemplary GUI rendering an interactive leadership board rendering performance parameters of a set of users after completion of an activity challenge, in accordance with an embodiment of the present disclosure.

FIG. 9 illustrates an exemplary GUI rendering an interactive leadership board depicting individual rankings of a set of users based on calories burned by each of the set of users associated with an activity challenge, in accordance with an embodiment of the present disclosure.

FIG. 10 illustrates an exemplary GUI rendering a reward leaderboard, in accordance with an embodiment of the present disclosure.

FIG. 11 illustrates an exemplary GUI rendering a list of notifications, in accordance with an embodiment of the present disclosure.

FIG. 12 illustrates a flowchart of a method monitoring user activities, in accordance with some embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

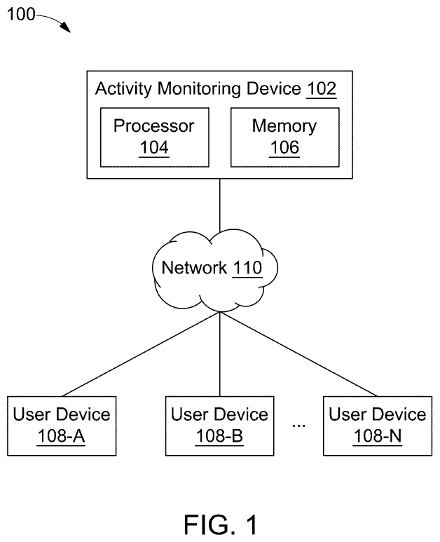

Referring now to FIG. 1, a block diagram of a system 100 for monitoring user activities is illustrated, in accordance with an embodiment of the current disclosure. The system 100 may include an activity monitoring device 102 communicably coupled with a plurality of user-devices 108A-108N (collectively referred to hereinafter as user-devices 108 and individually referred to hereinafter as user-device 108) via a wireless communication network 110. The activity monitoring device 102 may be implemented on a conventional or a general-purpose computer system, such as a personal computer (PC) or server computer. Further, the activity monitoring device 102 may include a processor 104 and a memory 106. Further, each of the plurality of user-devices 108A-108N may also include a processor (not shown) and a memory (not shown). In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™ system on a chip processors or other processors that can be used to execute similar functions. In an embodiment, the memory 106 may store instructions that, when executed by the processor 104, may cause the processor 104 to monitor user activities, as discussed in more detail below. In an embodiment, the memory 106 may be a non-volatile memory or a volatile memory. Examples of non-volatile memory may include, but are not limited to, a flash memory, a Read Only Memory (ROM), a Programmable ROM (PROM), Erasable PROM (EPROM), and Electrically EPROM (EEPROM) memory. Further, examples of volatile memory may include, but are not limited to, Dynamic Random Access Memory (DRAM), and Static Random-Access memory (SRAM).

In an embodiment, the communication network 110 may be a wired or a wireless network or a combination thereof. The network 110 can be implemented as one of the different types of networks, such as but not limited to, ethernet IP network, intranet, local area network (LAN), wide area network (WAN), the internet, Wi-Fi, LTE network, CDMA network, 5G and the like. Further, the network 110 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 110 can include a variety of network devices, including routers, bridges, servers, computing devices, storage devices, and the like.

Further, in an embodiment, the user-device 108 may be a smart device such as, but not limited to, a smart mirror as disclosed in U.S. Non-Provisional application Ser. No. 17/467,386 filed on Sep. 6, 2021, which is hereby incorporated by reference in its entirety. In another embodiment, the user-device 108 may be, but not limited to, a standalone smart device for example, mobile phones, tablets, TVs, laptops, and the like. It may be noted that the user-device 108 may enable training a user to perform physical activities and may be configured for analysing activity performance by a user standing in front.

In another embodiment, a user devices 108 may be coupled to a smart mirror that may be configured as a rendering device that may enable training a user to perform physical activities. Further, the user device 108 as a standalone device or coupled to a smart mirror may be provided in a room, area, or a hall, where one or more users may perform physical activities or workouts. The user devices 108 may include one or more cameras, display screens, one or more processors (not shown), a memory (not shown), a microphone (not shown), one or more sensors (not shown), and a speaker (not shown). The one or more cameras, for example, may be infrared cameras, motion detection cameras, or the like. In addition, the user devices 108 may be couplable to external cameras, sensor and display device such as, but not limited to, the smart mirror. The cameras may enable capturing more information about a corresponding user of the user device 108 and the user environment. Examples of one or more sensors may include, but are not limited to Light Detection and Ranging (LiDAR), infrared sensor, motion sensor, proximity sensor, temperature sensors, humidity sensors, and the like

The user-devices 108 may connect and communicate with other computing devices (for example, a mobile phone, a laptop, a desktop, or a Personal Digital Assistants (PDA), and so forth), smart watches, fitness trackers, fitness bands, biometric sensors placed on a user, smart mirrors and display devices over a communication network (for example, a cellular network, WiFi Bluetooth, internet, or the like). The other computing devices connected to the user-devices 108 may also be communicatively coupled to the activity monitoring device 102 over the communication network 110. In such case and in some embodiments, the activity monitoring device 102 may be configured to enable the user-devices 108 via the corresponding other computing devices to provide AI assisted activity training and monitoring user activity to the corresponding users.

In an embodiment, the user-devices 108 may be operated or controlled by a user using voice-based inputs. The voice-based input may be received from a user, via a microphone, and may be processed by a Natural Language Processing (NLP) model configured within the user-devices 108. Examples of the NLP model may include but are not limited to Bidirectional Encoder Representations from Transformers (BERT), Robustly Optimized BERT Pretraining Approach (ROBERTa), ALBERT XLNet, and the like.

It may be noted that in addition to and in combination with the voice-based inputs, each of the user-devices 102 may also be operated or controlled using one or more of, but not limited to touch gestures, air gestures, eye gestures, biometric inputs, game controllers, inputs via one or more input devices such as keyboard, mouse, touch pad, stylus, and the like.

Also, each of the user-devices 108 may be operated or accessed based on authentication of a corresponding user using various security mechanisms. The authentication may ensure that an unauthorized user is not able to access the user-device 108 and/or the associated devices such as, but not limited to, smart mirror, smart watches, and the like. Examples of such security mechanisms may include, but are not limited to alphanumeric password, pattern based passwords, voice recognition, biometric data (for example, retina scan, fingerprint, facial recognition, or heartbeat signature), One time Password (OTP), private key pairing, RFID tags, NFC tags, or proximity of a registered smart device.

The activity monitoring device 102 may be configured to monitor the activities performed by one or more users while training in front of a smart mirror or a corresponding user device 108. In an embodiment, each of the user devices 108A-108N may have a mobile application installed on it. The mobile application may provide AI assisted activity training and allow monitoring activity performed by users while training as discussed in detail in subsequent FIG. In another embodiment, a webapp may be utilized by the user-devices 108 to access an online content in real time provided by the activity monitoring device 102. The webapp may optionally include one or more webpages that may be accessed by the user-devices 108 such as, but not including, a smart device, a tablet, a screen display, a television screen, a smart mirror, or a monitor, and the like.

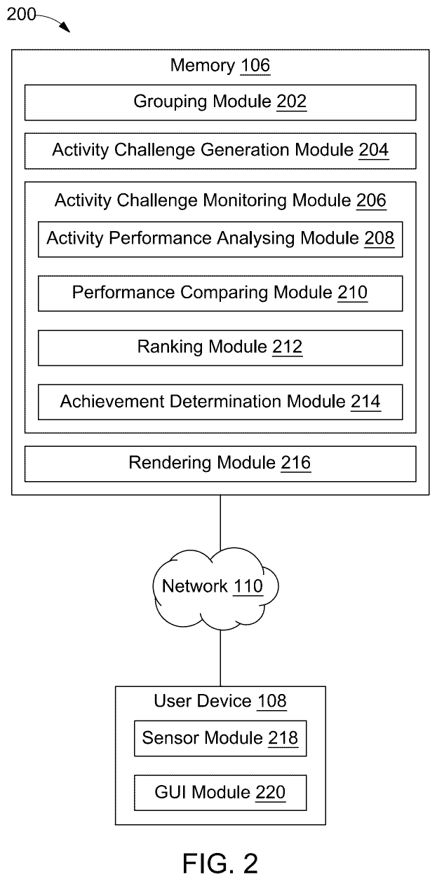

FIG. 2 illustrates a functional block diagram 200 of the activity monitoring device 102 and the user-device 108, in accordance with an embodiment of the disclosure. In one embodiment, the memory 106 of the activity monitoring device 102 may include a grouping module 202, an activity challenge generation module 204, an activity challenge monitoring module 206 and a rendering module 216. The activity challenge monitoring module 206 may further include an activity performance analysing module 208, a performance comparing module 210, a ranking module 212, and an achievement determination module 214. Further, the memory of each of the plurality of user-devices 108 may include a sensor module 218, and a GUI module 220.

It may be noted that the sensor module 218 of a user-device 108 may determine sensor data from the one or more sensors provided in the user-device 108 or external devices connected to the user-device 108. The sensor data may include real-time location, haptic information, biometrics parameters of users, performance parameters, and the like. Further, the GUI module 220 may be configured to render an interface to receive user-input and output information to the users such as performance parameters, alerts, audio-visual instructions, and the like. In an embodiment, the GUI module 220 may allow the users to access various functionalities of a webapp to access an online content in real time provided by the activity monitoring device 102.

In an embodiment, the grouping module 202 may select a plurality of users based on a first grouping criteria. In one example, the first grouping criteria may be defined based on a manual input received from one of the plurality of users for selecting the plurality of users. In another example, the first grouping criteria may be defined based on one or more common attributes determined for the plurality of users. In an example, one or more common attributes may be determined based on user profile or performance data of users.

A user may be required to create a user profile to access content provided by the activity monitoring device 102. A user profile may be created when a mobile application is installed on the user-device 108. In order to create a user profile, a user may be required to input various information such as, but not limited to, personal information (name, age, and the like), demographic information, anthropometric measurements, and the like. In an example, a user may be sponsored or recommended by a friend, employer, doctor, fitness coach, and the like. Thus, the user-profile may include sponsor or recommendation details. The user profiles may be saved in a server database (not shown) and utilized by the activity monitoring device 102 to provide AI-assisted activity training and monitor activity performed by the users as discussed in detail below. In one example, based on the user profile information a customized AI-assisted activity training and monitoring may be provided by the activity monitoring device 102. In an embodiment, user profile may be created automatically based on the connection of the user-device 108 to social media applications, such as, but not limited to, FACEBOOK™, GOOGLE™, and the like.

Referring back to FIG. 2, the grouping module 202 may select a plurality of users based on a manual input provided by one of the plurality of users. In an example, a user of a user-device 108 or an admin user operating the activity monitoring device 102 may provide a manual input to define a first grouping criterion. In an example, a user input may define the first grouping criteria by manually selecting users from the plurality of users. In another example, a user may define a common attribute based on which the plurality of users may be selected. For example, a user may define a plurality of users belonging to a particular organization may be selected. Further, the grouping module 202 may determine one or more common attributes for the plurality of users in order to select them. In an example, one or more common attributes may be determined by the grouping module 202 from various attributes associated to each of the plurality of users such as, but not limited to, demographic information, historical performance, and the like. In one example, demographic information may include, but not limited to, age, gender, employment, occupation, and the like. For example, but not limited to, users that belong to a particular organization or users which have performed a predefined number of squats, users that belong to a particular location, may be selected. In an example, a plurality of users belonging to a particular organization across the world may be selected. In another example, a plurality of users belonging to a predefined age group such as, but not limited to, 35-40 years, may be selected.

Further, the activity challenge generation module 204 may generate an activity challenge. The activity challenge may be associated with at least one activity and a set of Key Performance Indicators (KPIs). The at least one activity may be selected from one or more activity categories including, but not limited to, exercise, meditation, yoga, Pilates, martial arts, ikebana (flower arrangement), origami, painting, sculpting, pottery, physical rehabilitation, cooking, dancing, boxing, physical therapy and rehabilitation, CrossFit, Les Mills, F45, Zumba, Bikram Yoga, Orange Theory, or the like. In one example, the yoga category may include several activities such as, but not limited to, Surya namaskar, Hatha yoga, mountain pose, moon salutation, and the like. In another example, the exercise category may include, but not limited to, warmup moves, resistance training, core stability, calisthenics, weight resistance, and the like. Other examples of exercise categories may include, but not limited to, ‘all’ activity category, an ‘arms’ activity category, a ‘chest’ activity category, a ‘lunges’ activity category, a ‘legs’ activity category, a ‘quads’ activity category, a ‘shoulder’ activity category, a ‘squats’ activity category and a ‘triceps’ activity category. Under the ‘all’ activity category, the presented multiple activities, for example, may include lateral squats, side lunges, side squats, side burpees, side push-ups, front overhead triceps, front push-ups, dumbbell squat press, front squats, and/or front lunges.

The activity challenge generation module 204 may select one or more activities from one or more exercise categories for the activity challenge. The activity challenge generation module 204 may select one or more activities automatically or based on an input received from one or more of the plurality of users or the admin user.

Further, the set of KPIs may include, but not limited to, a predefined duration of the activity challenge, a predefined sub-duration of the activity challenge, a number of sets of the at least one activity, a number of repetitions of the at least one activity in each set of the at least one activity, a target number of calories, a target accuracy level of the at least one activity, and a duration of rest time between consecutive sets of the at least one activity, intensity of performing the at least one activity, difficulty level of the at least one activity, pace of performing the at least one activity, and the like.

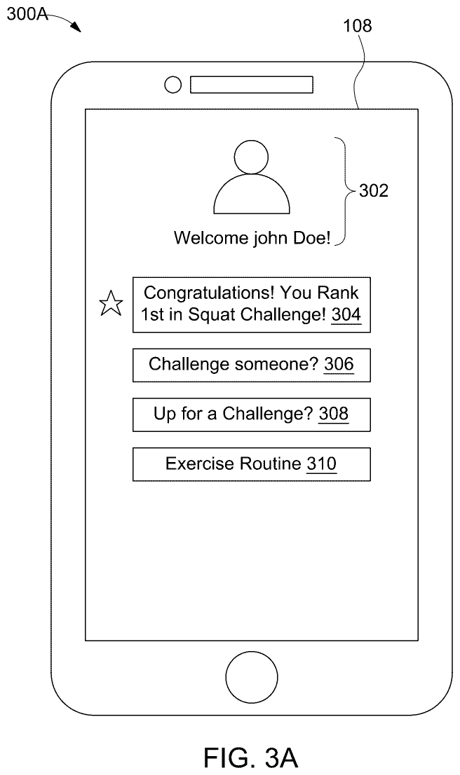

Referring now to FIG. 3A and FIG. 3B, exemplary GUIs 300A and 300B for generating an activity challenge is illustrated, in accordance with some embodiments. The GUI 300A may be rendered on a user device 108 to enable a user from the plurality of users to generate an activity challenge. Further, the GUI 300B may be rendered on a user device 108 to enable an admin user to generate an activity challenge. The exemplary GUI 300A depicts one or more attributes 302 of a user such as name, and the like. Further, the GUI 300A depicts a performance parameter 304 of a user of the user-device 108 such as, but not limited to, group ranking in a group activity, individual ranking in a group activity, individual ranking based on individual performance, and so on. as described in more detail below. Further, the GUI 300A may provide various options for a user to select such as, but not limited to, to create a new activity challenge 306, to perform an activity challenge 308 and to perform an exercise routine 310. Accordingly, in case a user may select the option to create a new activity challenge 306. The activity challenge generation module 204 may initiate the steps to create a new activity challenge. Similarly, the exemplary GUI 300B depicts one or more attributes 312 of an admin user. Further, the exemplary GUI 300B includes one or more options 314 for the admin user to select to create an activity challenge. Further, the exemplary GUI 300B may depict a list of activity challenges 316 that may have been created. In one embodiment, the list of activity challenges 316 may include active activity challenges and historical activity challenges that may have gotten over. In an embodiment, an admin user may select a historical challenge to reinitiate it by updating the associated KPIs.

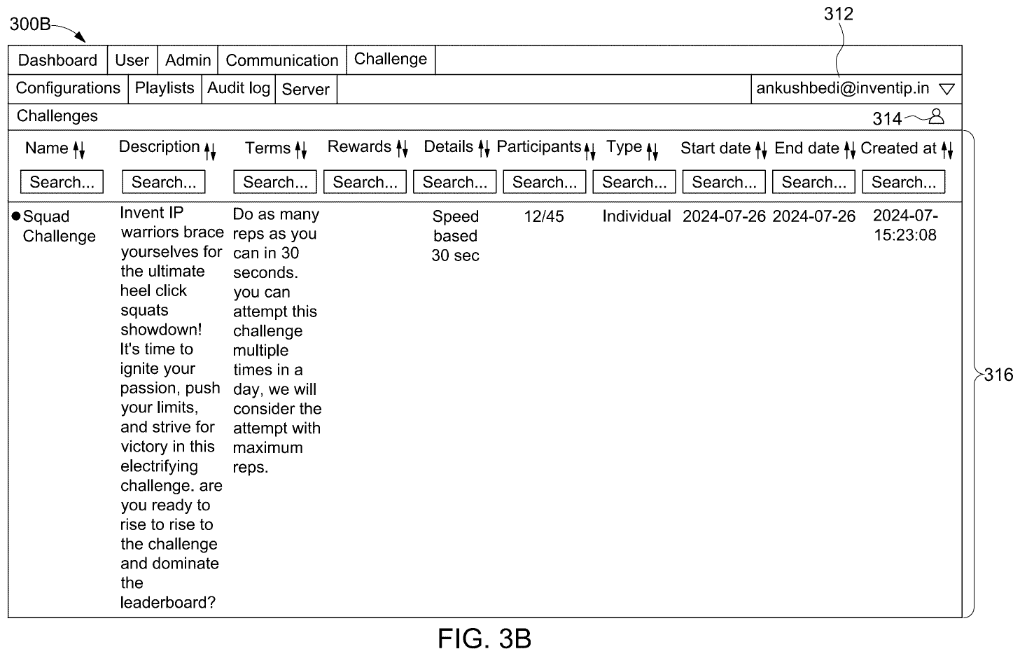

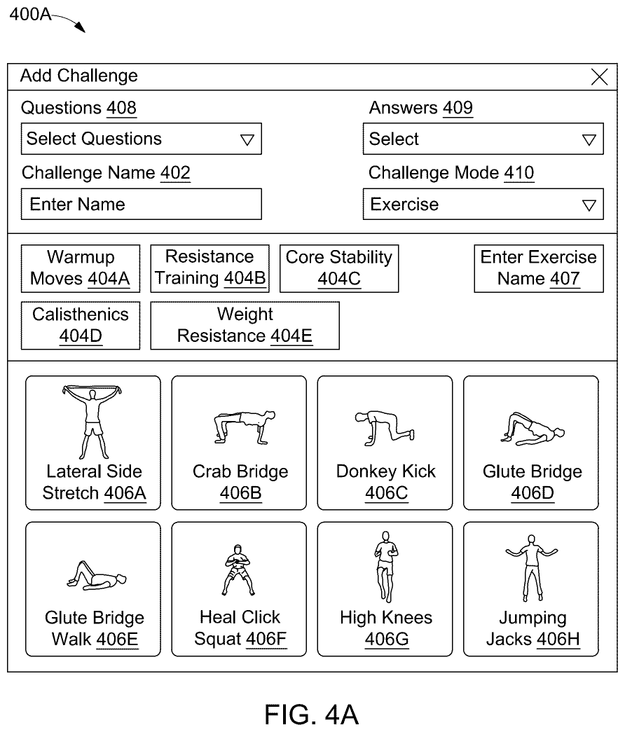

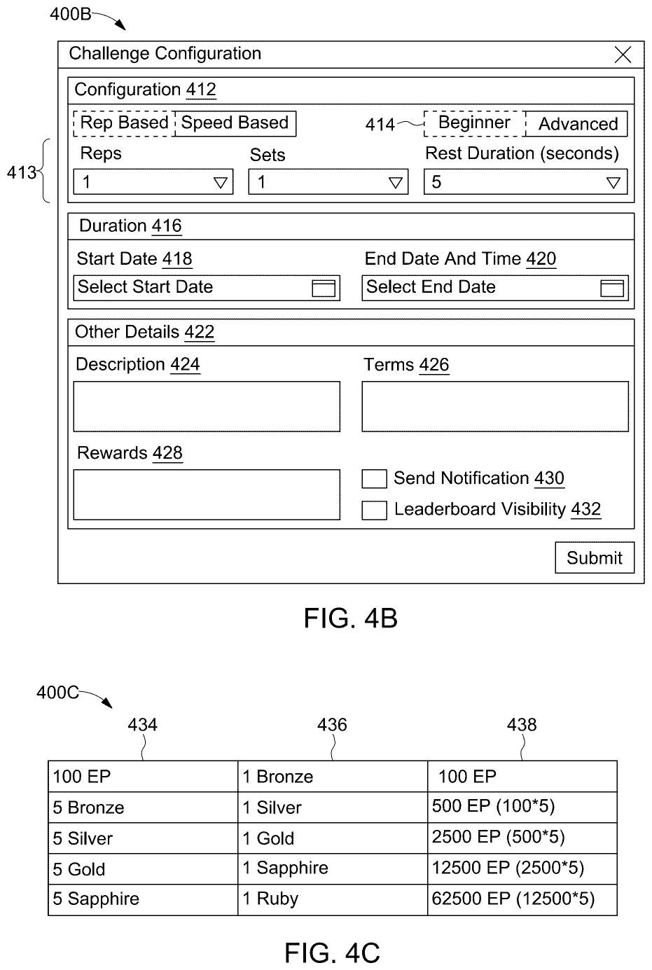

Referring now to FIG. 4A, an exemplary GUI 400A for generating an activity challenge is illustrated, in accordance with some embodiments of the present disclosure. The GUI 400A may allow a user or an admin user to input a name 402 of the activity challenge. In an example, user may assign a name 402 of the activity challenge related to the at least one activity or KPIs associated with the activity challenge such as, but not limited to, “Jumping Jacks Team Challenge”, “Squat Challenge”, “Weekly Challenge”, “Monthly Challenge”, and the like.

Further, the GUI 400A may depict various categories of activities 404A-404E for the user to select. As shown in FIG. 4, each category of activities 404A-404E may include a plurality of activities. In an example, the category 404A “Warmup Moves”, may include a plurality of activities 406A-406H. Accordingly, the user or the admin user may select one or more activities 406A-406H from one or more categories of activities 404A-404E to generate the activity challenge. Further, the GUI 400 may allow users to search for any activity belonging to any of the categories of activities 404A-404E by inputting a keyword in a search interface 407. Further, the user or the admin user may specify a question 408 that may be shared with each of the plurality of users that may accept to perform the activity challenge. In an embodiment, the question 408 may be to seek input regarding an attribute related to the user. For example, but not limited to, the question 408 may determine an office location of a user, an age group of the user, a department of an organization, designation, and the like. Further, one or more options may be provided for an answer 409 to the question 408 to be selected by a user when accepting an activity challenge as described in detail below. Further, a challenge mode 410 may be defined as one of: exercise mode or a circuit mode. In the exercise mode one activity 408 from one of the categories of activities 404A-404E may be selected. In the circuit mode one or more activities from a plurality of the categories of activities 404A-404E may be selected.

Referring now to FIG. 4B, an exemplary GUI 400B rendered for defining KPIs of an activity challenge is illustrated, in accordance with some embodiments of the present disclosure. As shown, the exemplary GUI 400B may allow a user or an admin user to define a configuration 412 of the activity challenge. In an example, the configuration type 412 of the activity challenge may be based on, but not limited to, repetitions, speed, calories, target accuracy, target parametric goal, and the like. It may be noted based on the configuration type 412, the exemplary GUI 400B may allow users to define one or more KPIs 413 associated to the activity challenge. For example, the configuration type 412 “repetition” may include one or more KPIs 413 such as, but not limited to, a number of sets, a number of repetitions to be performed in each set, a rest duration between each set, and the like. Further, the exemplary GUI 400B may allow a user to define a difficulty level 414 of the activity challenge such as, but not limited to, beginner, medium, advanced, and so on. Furthermore, the GUI 400B may allow users to define a duration 416 of the activity challenge by defining a start date 418 and an end date 420. Further, the GUI 400B may allow users to define other details 422 related to the activity challenge such as, but not limited to, description 424, terms 426, rewards 428, and so on. In an example, the description 424 may provide information related to at least one activity associated with the activity challenge. In an example, terms 426 may define disclaimers for users. In an example, rewards 428 may define reward points that may be associated to various milestones associated to the activity challenge that may be awarded to users during the activity challenge. In an embodiment, a reward reference table may be defined to define the reward points that may be associated to various milestones associated to the activity challenge.

FIG. 4C illustrates a reward reference table 400C, in accordance with an embodiment of the present disclosure. In an embodiment, effort points (EP) may be rewarded based on performance of at least one activity associated with the activity challenge and progression of performance parameters towards achievement of the set of KPIs associated with the activity challenge. A set of reward badges may be predefined such as, but not limited to, bronze, silver, gold, sapphire, ruby, and so on. Further, the set of reward badges may depict a hierarchy of achievement such as ruby badge may be highest in hierarchy and bronze badge being lowest in hierarchy. As depicted in the reward reference table 400 column 438 depicts a reference number of effort points that are to be earned to achieve a reward badge mentioned in column 436. Further, column 434 provides a reference number of reward badges to earn a higher ranking reward badge. For example, earning 1 silver badge may be assigned after earning 5 bronze badges, and so on.

Referring back to FIG. 2, the activity challenge monitoring module 206 may receive an input corresponding to an acceptance of the activity challenge via a Graphical User Interface (GUI) module 220 of an associated user-device 108 of a user. In an example, a notification may be sent to each of the plurality of users selected based on the first grouping criteria once an activity challenge is generated by the activity challenge generation module 204. Upon receiving the notification regarding the generation of the activity challenge, a set of users from the plurality of users may accept the activity challenge by providing an input via a GUI of an associated user-device 108. Assuming that a set users from the plurality of users accepted the activity challenge, the grouping module 202 may further divide the set users into a plurality of subsets of users based on at least one of: attributes of each of the set of users, and the set of KPIs associated with the activity challenge.

In one example, the grouping module 202 may determine a plurality of subsets of users from a plurality of set of users based on an attribute of each of the set of users such as, but not limited to, users belonging to a particular organization that has offices in locations “Gurugram” and “Noida”. Accordingly, the grouping module 202 may create one subset of users who have selected their location as “Noida”. Further, the grouping module 202 may create another subset of users who have selected their location 304 as “Gurugram”.

In another example, in case the set of KPIs associated with the activity challenge includes a target accuracy level of the at least one activity, the grouping module 202 may create a plurality of subsets of users from the set of users that have an average accuracy level of about 80% for performing the at least one activity. Thus, each subset of users may have an average accuracy level of about 80% for performing the at least one activity.

Further, the grouping module 202 may create a plurality of groups of users from one or more of the plurality of subsets of users based on a second grouping criteria. For example, the subset of users belonging to “Noida” may further be divided into a plurality of groups based on a second grouping criteria. The second grouping criteria may include a manual input received from one of the associated subset of users, one or more common attributes determined for the associated subset of users, and one or more common performance parameters determined based on the result of the comparing and the subset of KPIs.

For example, a plurality of groups from a subset of users belonging to “Noida” may be created in case one user of the associated subset of users manually selects one or more users of the associated subset of users for each of the plurality groups. Further, one user of the associated subset of users may manually select one or more common attributes for the associated subset of users for example, but not limited to, users that live in a particular location within the Noida location, and the like. Further, the grouping module 202 may automatically create a plurality of groups from a subset of users based on determination of one or more common attributes determined for the associated subset of users. In an example, users of the subset of users belonging to “Noida” location may be further divided into group of users based on sub-locations in “Noida” or “Gurugram” location. For example, a group of users may be created to include users that belong to sectors 124, 125 and 128 in “Noida” location and another group of users may be created with users that belong to sectors 76, 100 and 104 in “Noida” location and so on. Further, the grouping module 202 may determine one or more common performance parameters of a subset of users. For example, users that have performed an activity with an accuracy greater than 90% may be grouped into a plurality of groups, and so on. Further, a plurality of groups from a subset of users may be created based on attributes such as gender, age, tenure, designation, team, in an organization, and the like.

In an embodiment, the activity challenge generation module 204 may generate a sub-activity challenge corresponding to the activity challenge. The sub-activity challenge may be associated with at least one sub-activity of the at least one activity and a subset of KPIs. In an example, an activity challenge is created for performing an activity of “jumping jacks”. Further, the associated set of KPIs include 3 sets and 30 repetitions per set and a break time of 10 seconds between each set. A sub-activity challenge may be created for a plurality of group of users by defining the at least one sub-activity as “jumping jacks” and the associated subset of KPIs as a maximum number of repetitions in 30 seconds of time duration. In an embodiment, each of the plurality of groups may receive a notification based on the generation of the sub-activity challenge.

It may be noted that, the grouping module 202 may create one or more sub-groups of one or more users from a group of users from the plurality of groups based on a predefined a sub-grouping criteria similar to the first grouping criteria or the second grouping criteria. Further, the activity challenge generation module 204 may generate an activity challenge for the one or more sub-groups similar to the sub-activity challenge. It may be noted that the activity challenges may be suitably created to motivated users to perform activities in case performance of activities by a user decreases or performance of a user decreases. In one embodiment, one user from the set of users may select another user from the set of users to perform the activity challenge with a predefined subset of KPIs based on the set of KPIs associated with the activity challenge. For example, a user may challenge another user from the set of users to perform a “jumping jack challenge” by performing a maximum number of jumping jacks in 30 seconds.

Referring back to FIG. 2, upon acceptance of the activity challenge by the set of users, the activity challenge monitoring module 206 may provide a notification to each of the set of users regarding initiating the activity challenge based on a predefined duration of the activity challenge. In an embodiment, the notification may be provided as a reminder to each of the set of users to perform the activity challenge after a predefined interval during the predefined duration of the activity challenge.

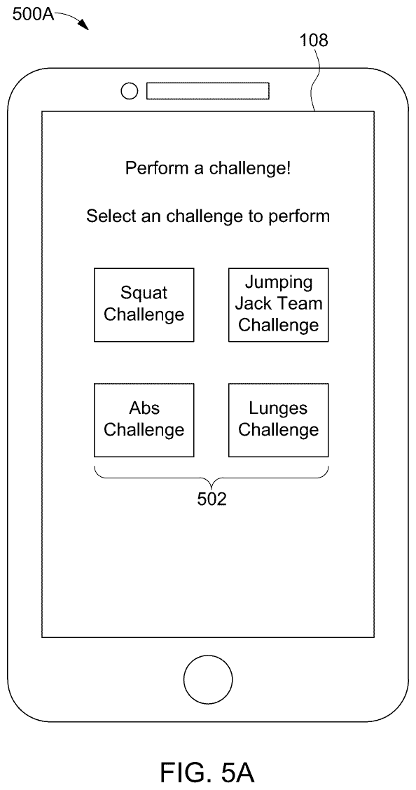

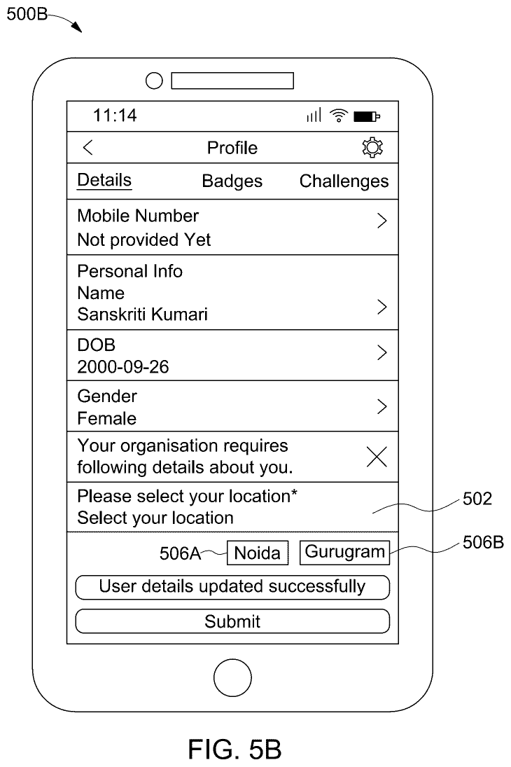

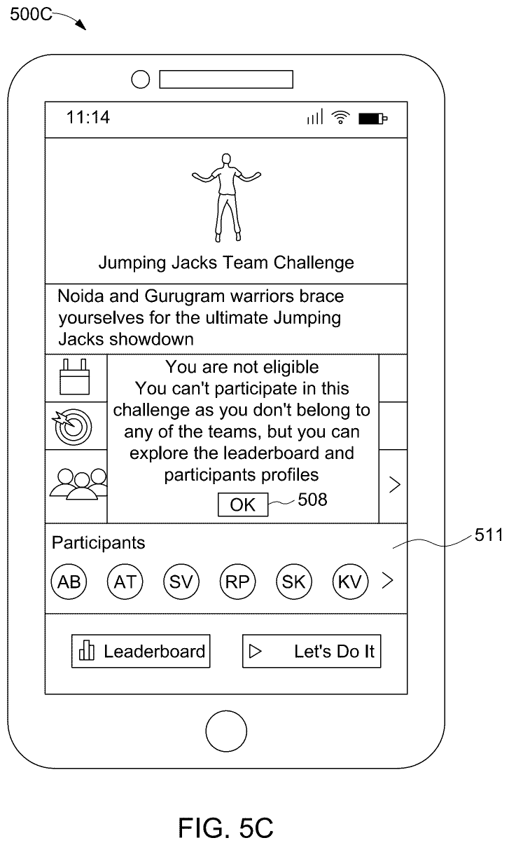

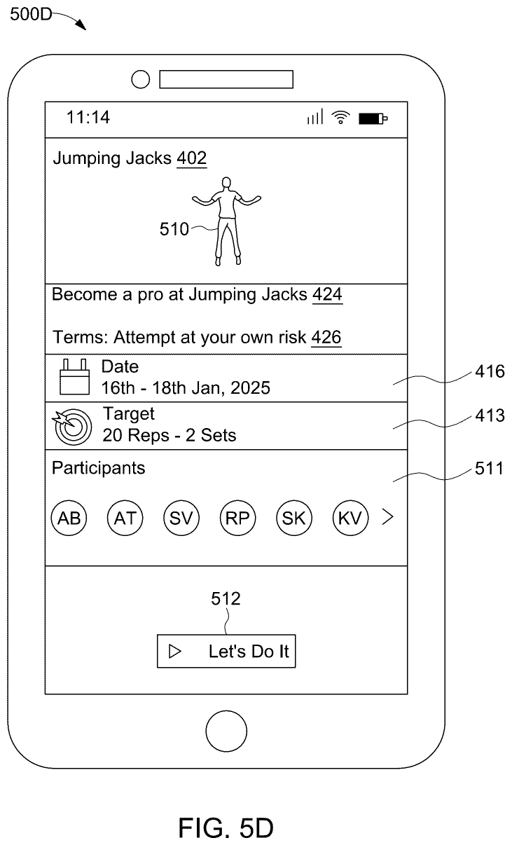

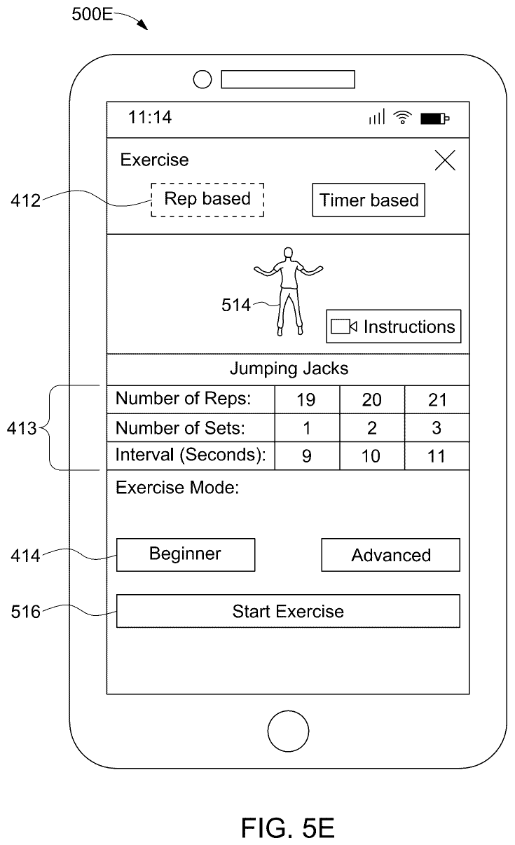

Referring now to FIG. 5A, an exemplary GUI 500A rendered on a user-device 108 listing a list of activity challenges is illustrated, in accordance with some embodiments of the present disclosure. The exemplary GUI 500A may render a list of activity challenges 502. The list of activity challenges 502 may include past activity challenges and active activity challenges. A user may select one of the active challenges from the list of activity challenges 502 to provide acceptance of the corresponding activity challenge.

Referring now to FIG. 5B, an exemplary GUI 500B rendered on a user-device 108 when an activity challenge is selected in order to be accepted is illustrated, in accordance with some embodiments of the present disclosure. As discussed earlier, assuming a set of users select an activity challenge to indicate acceptance to perform the activity challenge, the exemplary GUI 500B is rendered to each of the set of users. The exemplary GUI 500B illustrates a pop-up page 504 displaying the question 408 input during the generation of the activity challenge as described in FIG. 4A. The exemplary GUI 500B depicts the question 408 to select a location of the user by selecting from options 410 as “Noida” 506A or “Gurugram” 506B. Accordingly, as per the exemplary embodiment of FIG. 5B, one subset of users may be created to include users from the set of user that selected “Noida” as their location. Similarly, another subset of users may be created from the set of users that selected “Gurugram” as their location.

FIG. 5C illustrates an exemplary GUI 500C displaying an error notification 604, in accordance with an embodiment of the present disclosure. Further, in case a user not selected as one of the plurality of users by the grouping module 202 selects to perform an activity challenge from the list of activity challenges 502, an error notification may be displayed to the user. In another embodiment, one or more sub-activity challenges may also be listed in the rendered list of activity challenges 502 in case one or more sub-activity challenges has been generated. The GUI 500C illustrates an error notification 508 that may pop up on the GUI 500C in case a user not selected as the plurality of user by the grouping module 202 may try to accept an activity challenge.

FIG. 5D illustrates an exemplary GUI 500D rendered on a user device 108 to provide an acceptance of an activity challenge, in accordance with an embodiment of the present disclosure. The exemplary GUI 500D depicts the name 402 of the activity challenge as defined earlier while generation of the activity challenge. The exemplary GUI 500D depicts an animation 510 providing one or more guidance steps of the at least one activity 406 associated with the activity challenge as defined earlier while generation of the activity challenge. The exemplary GUI 500D depicts the KPIs 413 associated with the activity challenge as defined earlier while generation of the activity challenge. The exemplary GUI 500D depicts the predefined duration 416 of the activity challenge, the start date 418 and the end date 420. Further, the exemplary GUI 500D depicts the description 424 and the terms 426 associated with the activity challenge as defined earlier while generation of the activity challenge. Further, the exemplary GUI 500D renders a list of the set of users as “Participants” 511 that have accepted to perform the activity challenge and are participating in the activity challenge. A user may provide an acceptance of the activity challenge by selecting the “Let's do it” option 512 rendered on the exemplary GUI 500D. In an embodiment, a user from the plurality of users may be motivated by viewing the “Participants” 511 and may accept to perform the activity challenge in a competitive spirit.

FIG. 5E illustrates an exemplary GUI 500E rendered on a user-device 108 for initiating an activity challenge is illustrated, in accordance with some embodiments of the present disclosure. The exemplary GUI 500E depicts an animation 510 providing one or more guidance steps of the at least one activity 406 associated with the activity challenge as defined earlier while generation of the activity challenge. The exemplary GUI 500E depicts the configuration type 412, the KPIs 413 and the difficulty level 414 as defined earlier while generation of the activity challenge. Further, the user may initiate the activity challenge by selecting the “Start Exercise” option 516 rendered on the exemplary GUI 500E to perform the at least one activity.

Referring back to FIG. 2, the activity performance analysing module 208 may analyze the at least one activity performed by each user in plurality of subsets of users to determine performance parameters of each user in the plurality of subsets of users, in response to initiation of the activity challenge by an associated user. The activity performance analysing module 208 may capture, via at least one multimedia input device, a real-time video of the at least one activity performed by each user in the plurality of subsets of users. It may be noted that the analyzing is performed contemporaneously to the capturing.

In an embodiment, initiation of an activity challenge or sub-activity challenge by a user of an associated subset of users or an associated group of users respectively, may include displaying multimedia content and information via a display device connected to the associated user device 108. The display device may include for example, may be a smart TV, a mobile phone, a laptop, a tablet, or a smart projector with inbuilt camera. The display device may include a display screen that may be used to present the user with information and multimedia content related to the activity challenge or the sub-activity challenge.

In an embodiment, the description 424 and the terms 426 as depicted in FIG. 4B may be displayed on the display device. In an embodiment, a user acknowledgment related to acceptance of the terms 426 may be requested before initiation of the activity challenge or the sub-activity challenge by the corresponding user. Further, a demonstration of a series of guidance steps of the at least one activity or sub-activity may be provided to the user by rendering a multimedia content related to the at least one activity. The guidance steps may include instructions related to correct posture, pose, and/or pace of performing an activity. By way of an example, when the activity is front squats, the guidance steps or instructions may include maintaining space between feet, bending position and angle of knees with respect to feet, and depth of the squat, placement of hands, correct orientation of a dumbbell or kettle bell, and/or angle of inclination of the back. In an embodiment, multimedia content may include a series of guidance steps depicted by means of an animation such as a virtual assistant. The virtual assistant, for example, may be an avatar (3D or 2D) of a user, a trainer or an expert who performs multiple guidance steps involved in a given activity or sub-activity.

In an embodiment, a countdown timer may be rendered on the display device for the user to initiate performance of the at least one activity or sub-activity after the countdown ends and in order for the user to perform the activity or sub-activity. One or more input multimedia devices, such as, but not limited to, camera may capture a video of the at least one activity performed by the user in real-time. The performance of a series of steps of the at least one activity or sub-activity by the user in response to the presented guidance steps may be captured.

Similarly, the activity performance analysing module 208 may analyze the at least one sub-activity performed by each user in plurality of groups of users to determine sub-activity performance parameters of each user in the plurality of groups of users, in response to initiation of the sub-activity challenge by an associated user. The activity performance analysing module 208 may capture, via at least one multimedia input device, a real-time video of the at least one sub-activity performed by each user in the plurality of groups of users. It may be noted that the analyzing is performed contemporaneously to the capturing.

Based on the captured real-time video, the performance comparing module 210 may determine a pose skeleton model using an AI model. The AI model may determine joints of the user in the captured real-time video utilize to determine the pose skeleton model. Further, the performance comparing module 210 may overlay the captured real-time video of the user with the pose skeletal model and generate a real-time feedback for the user based on the result of the comparing and the overlaying of pose skeletal model. In an embodiment, the feedback may be rendered on the associated user device 108. Further, in an example, the feedback may include at least one of corrective actions or alerts generated as at least one of visual feedback, aural feedback, or haptic feedback. In an example, feedback may include corrective actions or alerts related to posture, pace, time spent, initiation and end of rest time, and the like.

It may be noted that the AI model may be trained to determine performance parameters based on the pose skeleton model. Further, the AI model may be trained to compare the determined performance parameters with at least one of the set of KPIs associated with the activity challenge. Examples of performance parameters may include, but not limited to, form accuracy, time duration of performance, calories burnt, number of sets performed, number of repetitions performed in each set, heart rate, step counts, and the like. Similarly, the AI model may be trained to determine sub-activity performance parameters based on the pose skeleton model. Further, the AI model may be trained to compare the determined sub-activity performance parameters with at least one of the subset of KPIs associated with the sub-activity challenge.

Once performance parameters for a user have been extracted, the AI model may compare the performance parameters with a set of target performance parameters. In a manner similar to the performance parameters, the set of target activity performance parameters may include, but are not limited to, target form accuracy, speed of the target activity performance, blood pressure, target number of repetitions, target pulse rate of the user, and target motion of the user. Upon observing a difference or deviation between the two set of parameters (i.e., user vs target), the AI model may generate a feedback for the user. The feedback may be instantly provided in real-time or contemporaneous to a user performing the at least one activity of the activity challenge.

In some configurations, the AI model may further include different portions of AI models, each of which is configured to perform distinct functionalities. For example, one AI model may be configured for pose matching, while other AI model may be configured for key point (or skeletal point) recognition. In such case, the AI model configured for pose matching may reside on a remote server, while the AI model configured for key point recognition may reside on an edge device, for example, the user device 108. As a result of assigning such distinct functionalities to different AI models, the requirement of transferring heavy data (for example, video data) to the remote server may not be required.

In an embodiment, multiple users from the plurality of subsets of users may simultaneously initiate the activity challenge or the sub-activity challenge and perform the at least one activity associated with the activity challenge or the at least one sub-activity associated with the sub-activity challenge, respectively. Thus, the activity performance analysing module 208 may analyse the at least one activity performed by each of the users and simultaneously the performance comparing module 210 may compare the performance parameters of each user in the plurality of subsets of users with at least one of the set of KPIs. Accordingly, the performance comparing module 210 may determine performance of each user relative to the remaining users in an associated subset of users from the plurality of subsets of users. Further, the performance comparing module 210 may determine performance of a first subset of users from the plurality of subsets of users relative to a remaining plurality of subsets of users.

Further, the performance comparing module 210 may determine a cumulative group performance of the first subset of users by cumulating the determined performance parameters of all users in the first subset of users in response to each instance of initiation of the activity challenge by the first subset of users during the predefined duration of the activity challenge.

Similarly, the activity performance analysing module 208 may analyse the at least one sub-activity performed by each of the users and simultaneously the performance comparing module 210 may compare the sub-activity performance parameters of each user in the plurality of groups of users with at least one of the subset of KPIs. Accordingly, the performance comparing module 210 may determine sub-activity performance of each user relative to the remaining users in an associated group of users from the plurality of groups of users. Further, the performance comparing module 210 may determine sub-activity performance of a first group of users from the plurality of groups of users relative to a remaining plurality of groups of users. The performance comparing module 210 may determine a cumulative sub-group performance of the first group of users by cumulating the determined performance parameters of all users in the first group of users in response to each instance of initiation of the sub-activity challenge by the first group of users during the predefined duration of the sub-activity challenge.

In an embodiment, the ranking module 212 may determine an individual ranking of a user relative to the remaining users in an associated subset of users from the plurality of subsets of users based on the performance of each user determined by the performance comparing module 210. Further, the ranking module 212 may determine a group ranking of each of the plurality of subsets of users by comparing one subset of users from the plurality of subsets of users relative to a remaining plurality of subsets of users based on the performance of each of the plurality of subsets of users determined by the performance comparing module 210.

The rendering module 218 may render a group progress report of the first subset of users from the plurality of subsets of users relative to each of the remaining plurality of subsets of users based on the determined cumulative group performance.

Further, the rendering module 218 may render, via the interactive leader board via the GUI module 220 of the corresponding user devices 108 of each of the plurality of subsets of users, indicating performance of each user relative to the remaining users in an associated subset of users from the plurality of subsets of users. Further, the rendering module 218 may render the interactive leader board indicating performance of a first subset of users from the plurality of subsets of users relative to a remaining plurality of subsets of users. In an example, the performance of each user relative to the remaining users in an associated subset of users from the plurality of subsets of users may be indicated by displaying, via the interactive leader board via the GUI module 220, individual ranking of each user relative to the remaining users in the associated subset of users from the plurality of subsets of users. Also, the rendering module 218 may indicate the performance by displaying, via the interactive leader board via the GUI module 220 of the corresponding user devices 108 of each of the plurality of subsets of users, group ranking of the first subset of users from the plurality of subsets of users relative to each of the remaining plurality of subsets of users. It may be noted, group ranking displayed to a user of the first subset of users may be for the subset of users to which the corresponding user belongs.

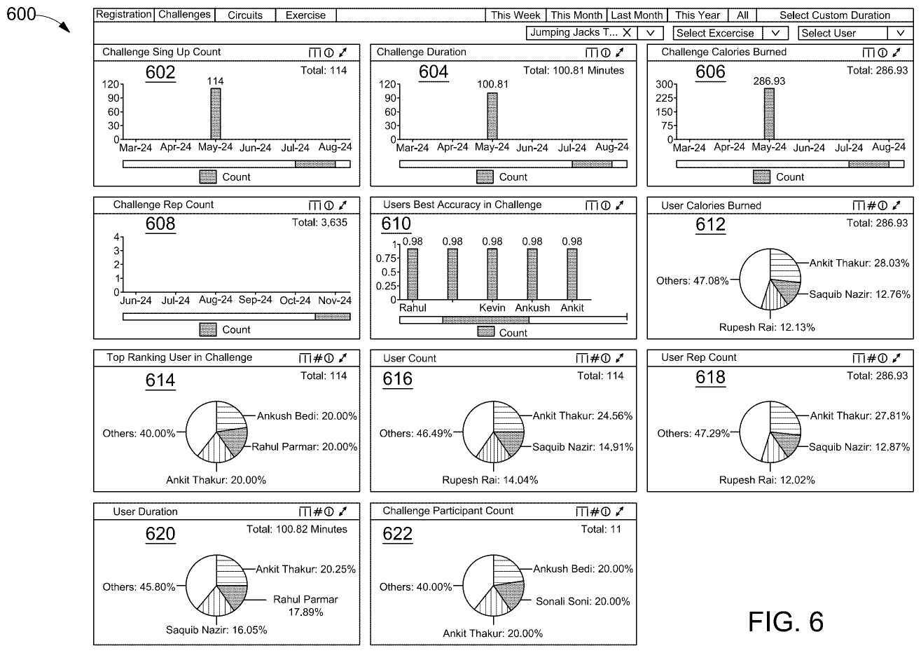

Referring now to FIG. 6, an exemplary GUI 600 indicates the performance parameters determined by the activity performance analysing module 208 of the activity monitoring device 102 is illustrated, in accordance with an embodiment of the present disclosure. The exemplary GUI 600 may indicate the performance parameters associated with an activity challenge such as, but not limited to, total sign up count of the activity challenge 602, total duration for which the activity challenge was performed 604, total calories burnt by the set of users by performing the activity challenge 606, total repetitions of at least one activity performed by each user 608 accuracy levels of each user 610. Further, graphical representation 612-622 of each of the performance parameters 602-610 may be depicted in the exemplary GUI 600 for ease of analysis by an admin user.

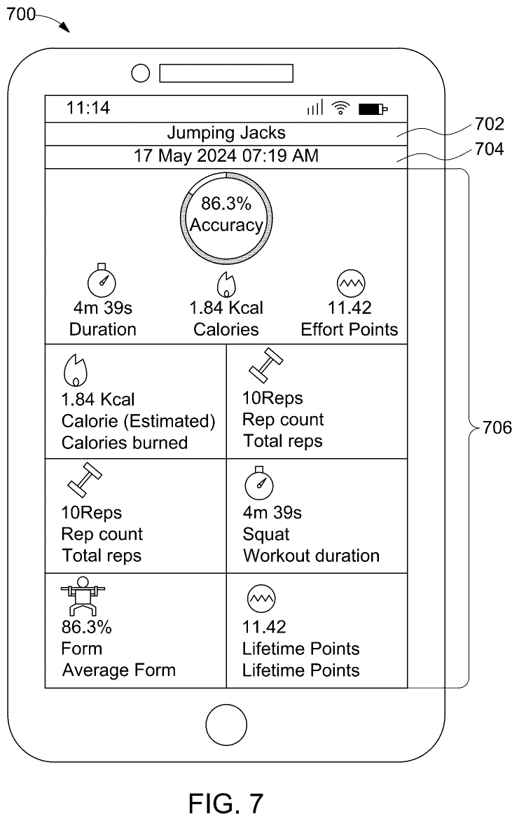

Referring now to FIG. 7, an exemplary GUI 700 indicating a performance report 702 of a user is illustrated, in accordance with an embodiment of the present disclosure. As can be seen, the performance report 702 displays information after performance of an instance of an activity challenge. Example of information related to an activity may include, but not limited to, name 702 and date and time when an activity is performed 704. Further, the GUI 700A displays one or more performance parameters 706 of a user as determined by the activity performance comparing module 210 based on completion of the performance of an activity such as, but not limited to, accuracy level of form, time duration of performing the activity, calories burned, number of sets completed, total number of repetitions, effort points earned, lifetime points earned, and the like.

It may be noted, performance of a user may vary over a duration of the activity challenge. In an example, the performance of the user may vary improve or deteriorate. Such change in the performance of a user may be determined by the performance comparing module 210 of FIG. 2 after each instance of the performance of the at least one activity. Referring back to FIG. 2, the performance comparing module 210 may identify a change in the performance of a user relative to the remaining users in the associated subset after each instance of the performance of the at least one activity. Accordingly, the performance comparing module 210 may identify a change in individual ranking based on change in the performance of the user relative to the remaining users in the associated subset after each instance of the performance of the at least one activity. Similarly, the performance comparing module 210 may also determine a change in the group ranking of the first subset of users from the plurality of subsets of users relative to each of the remaining plurality of subsets of users based on the change in performance.

It may be noted that the change in the individual rankings of each of the plurality of subsets of users may be computed by the performance comparing module 210 based on computation of at least one of: a number of instances of the performance of the at least one activity by each user during the predefined duration of the activity challenge, the maximum number of sets of the at least one activity performed by each user during the predefined duration of the activity challenge, the maximum number of repetitions of the at least one activity performed by each user during the predefined duration of the activity challenge, the maximum number of repetitions of the at least one activity performed by each user with the target accuracy level during the predefined duration of the activity challenge, the maximum number of sets of the at least one activity performed by each user during the predefined sub-durations of the activity challenge, and/or the maximum number of repetitions of the at least one activity performed by each user during the predefined sub-durations of the activity challenge.

It may be noted that the change in the group ranking of the first subset of users may be computed by the performance comparing module 210 based on computation of at least one of: a number of instances of the performance of the at least one activity by the first subset of users during the predefined duration of the activity challenge, the maximum number of sets of the at least one activity performed by the first subset of users during the predefined duration of the activity challenge, the maximum number of repetitions of the at least one activity performed by the first subset of users during the predefined duration of the activity challenge, the maximum number of repetitions of the at least one activity performed by the first subset of users with the target accuracy level during the predefined duration of the activity challenge, the maximum number of sets of the at least one activity performed by the first subset of users during the predefined sub-durations of the activity challenge, and/or the maximum number of repetitions of the at least one activity performed by the first subset of users during the predefined sub-durations of the activity challenge.

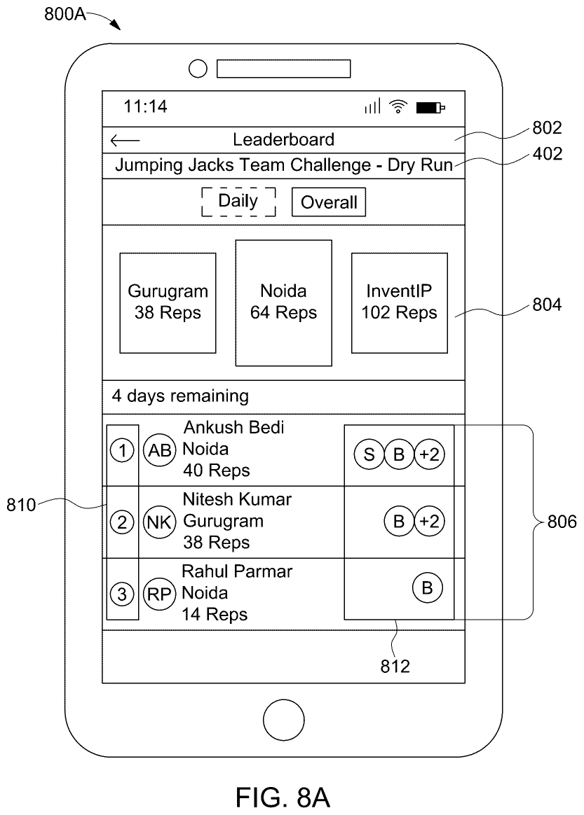

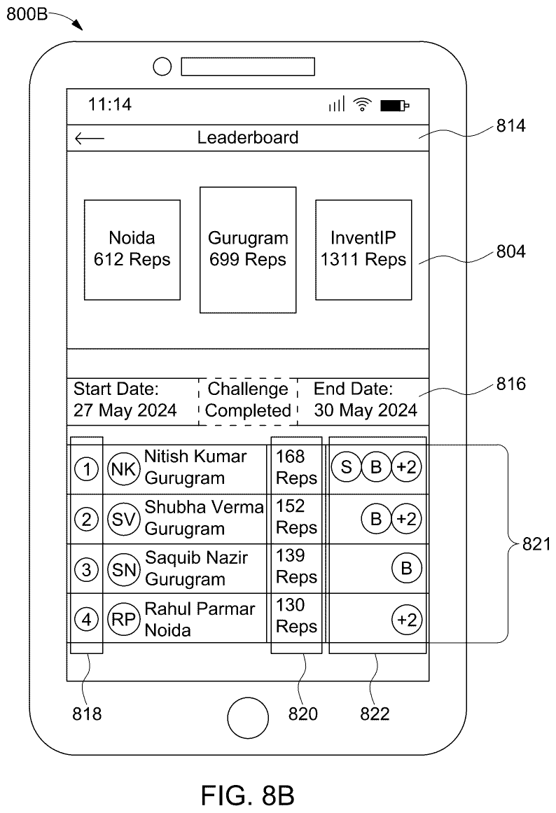

FIG. 8A illustrates an exemplary GUI 800A rendering an interactive leadership board 802 rendering performance parameters of a set of users associated with an activity challenge, in accordance with an embodiment of the present disclosure. It may be noted that the interactive leadership board 802 depicts the name 402 of the activity challenge. Further, the leadership board depicts various subsets of users and/or groups of users 804 created associated with the activity challenge and their group rankings. As shown, two subsets of users 804 created as “Noida” and “Gurugram” are shown. Further, the leadership board 802 depicts daily performance of the two subsets of users 804 after performance of the activity challenge for one day. For example, for the current day the leadership board 802 depicts that performance of subset “Noida” is winning with respect to a number of repetitions of the activity “jumping jack” performed and has a group ranking “1”. As can be seen, the subset “Noida” is shown to be leading based on 64 number of repetitions whereas the subset “Gurugram” is trailing with 38 number of repetitions and has a group ranking “2”. Further, the leadership board provides a list of set of users performing the activity challenge along with a number of repetitions of the activity “jumping jack” performed by each user 808A-808C, an individual rank 810 and associated subset 804 and one or more reward badges earned 812 by each user in the activity challenge. It may be noted that each user in the set of users is ranked based on descending number of repetitions of the activity “jumping jack” performed by each user. Further, the time duration remaining 808 from the predefined duration of the activity challenge may be depicted. A user may view the leadership board 802 to gauge their performance in comparison to other user participating in the activity challenge. Further, the leadership board 802 may motivate a user to perform better to rank higher with respect to other users, achieve milestones and earn reward badges. Similarly, the interactive leadership board 802 may indicate an overall performance of the set of users based on computation of the cumulative individual performance of the set of users.

FIG. 8B illustrates an exemplary GUI 800B rendering an interactive leadership board 814 rendering performance parameters of a set of users after completion of an activity challenge, in accordance with an embodiment of the present disclosure. It may be noted that the interactive leadership board 814 depicts various subsets of users and/or groups of users 804 created associated with the activity challenge. The interactive leadership board 814 depicts the status 816 of the activity challenge as “Challenge Completed” and the duration 416, the start date and the end date of the activity challenge. As shown, two subsets of users 804 created as “Noida” and “Gurugram” are shown along with their group rankings. Further, the leadership board 814 depicts group performance and cumulative individual performance of the two subsets of users 804 after completion of the activity challenge. For example, the leadership board 814 depicts that performance of subset “Gurugram” is winning with respect to a number of repetitions of the activity “jumping jack” performed and has a group ranking “1”. As can be seen, the subset “Gurugram” is shown to be leading based on 699 number of repetitions whereas the subset “Noida” is trailing with 612 number of repetitions and has a group ranking “2”. Further, the leadership board 814 provides a list of set of users 821 that participated in the activity challenge in order of their ranks 818 in the activity challenge. Further, a number of repetitions 820 of the activity “jumping jack” performed by each user 821 and one or more reward badges earned 822 by each user in the activity challenge. It may be noted that each user in the list of set of users is ranked based on descending number of repetitions of the activity “jumping jack” performed by each user. A user may view the leadership board 814 to gauge their performance in comparison to other user participating in the activity challenge. Further, the leadership board 814 may motivate a user to create more activity challenges and challenge other users.

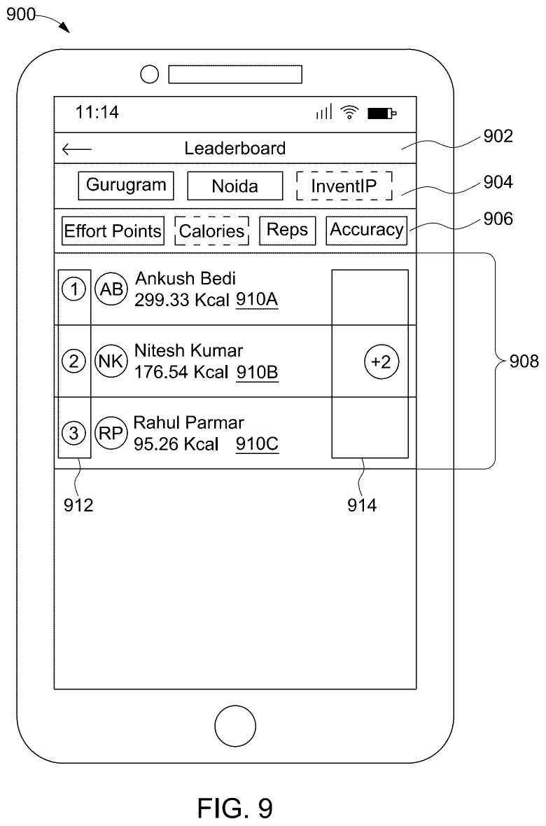

FIG. 9 illustrates an exemplary GUI 900 rendering an interactive leadership board 902 depicting individual rankings of a set of users based on calories burned by each of the set of users associated with an activity challenge, in accordance with an embodiment of the present disclosure. It may be noted that the interactive leadership board 902 lists two subsets of users and/or groups of users 904 created for the activity challenge. Further, the leadership board 902 may list performance parameters 906 such as, but not limited to, effort points, calories, number of repetitions, accuracy, and the like, for which individual rankings of the set of users may be rendered. As shown, two subsets of users 904 created as “inventip” and “Noida” are shown. Further, the leadership board 902 depicts performance with respect to performance parameter of “calories burnt” by each of a set of users performing the activity challenge. The leadership board lists the set of users 908 along with a number of calories burnt by each user 910A-910C, individual rankings 912 and one or more reward badges 914 earned by each user in the activity challenge.

The rendering module 218 may render, by the GUI module 220 of a corresponding user-device 108, a rank change notification based on the determined change in individual ranking of the corresponding user as discussed above. Further, rendering module 218 may render, by the GUI module 220, a group rank change notification based on the determined change in the individual ranking of the users.

The achievement determination module 214 may determine an achievement of at least one milestone from a plurality of predefined milestones, based on a result of the computations computed by the performance comparing module 210 for each user and/or for each subset of users from the plurality of subsets of users. In an example, a set of milestones may be predefined for an activity challenge or may be computed based on the KPIs associated with the activity challenge. In an embodiment, the achievement of a milestone may be determined based on the comparison of performance parameters of each user with at least one of the set of KPIs. For example, a milestone may be defined for each of: maximum number of instances of the performance of the activity challenge, maximum accuracy achieved, maximum number of sets performed, maximum number of repetitions performed, and so on.

Further, the achievement determination module 214 may identifying a reward badge associated with the at least one milestone achieved by the user. Example of reward badges may include bronze, silver, gold, sapphire, ruby, and so on. It may be noted that each milestone may be associated with one or more reward badges based on a predefined milestones reference table. In an embodiment, the predefined milestones reference table may list a plurality of milestones, and a corresponding threshold related to one or more performance parameters or KPIs.

Also, the achievement determination module 214 may determine achievement of at least one group milestone from a plurality of group milestones by each of the first subset of users from the plurality of subsets of users based on a comparison of the cumulative group performance with a corresponding predefined threshold associated with each of the plurality of group milestones. In an embodiment the predefined threshold associated with each of the plurality of group milestones may be defined based on the one or more KPIs associated with the activity challenge.

In an embodiment, a similar computation of cumulative group performance may be performed for each of the plurality of groups and a group progress report may be rendered for each of the plurality of groups based on the cumulative group performance in case of sub-activity challenge.

Further, the rendering module 216 may display, via the GUI module 220, a group achievement badge associated with the at least one group milestone in the group progress report of the first subset of users from the plurality of subsets of users.

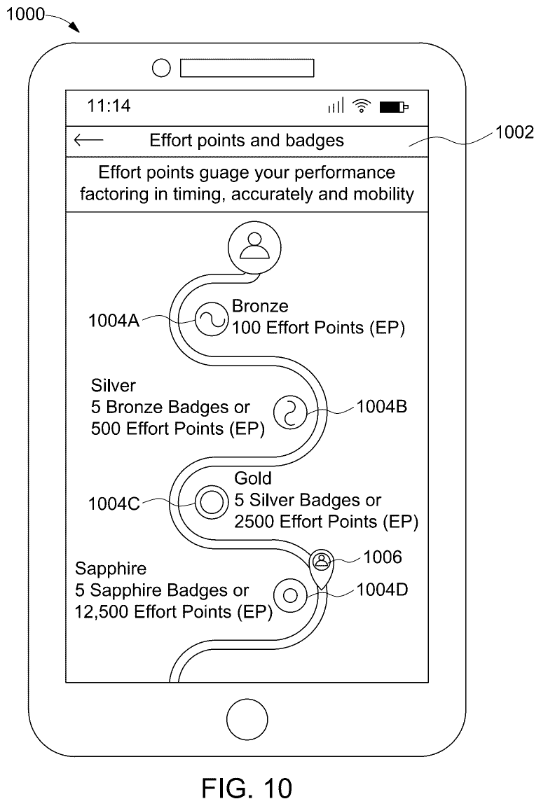

FIG. 10 illustrates an exemplary GUI 1000 rendering a reward leaderboard 1002, in accordance with an embodiment of the present disclosure. The reward leaderboard 1002 depicts a set of reward badges 1004A-1004D that may be earned by a user in a predefined duration of an activity challenge. Further, the reward leaderboard 1002 depicts current status 1006 of the user based on reward badges earned by a user based on a cumulative individual performance of the user in an activity challenge.

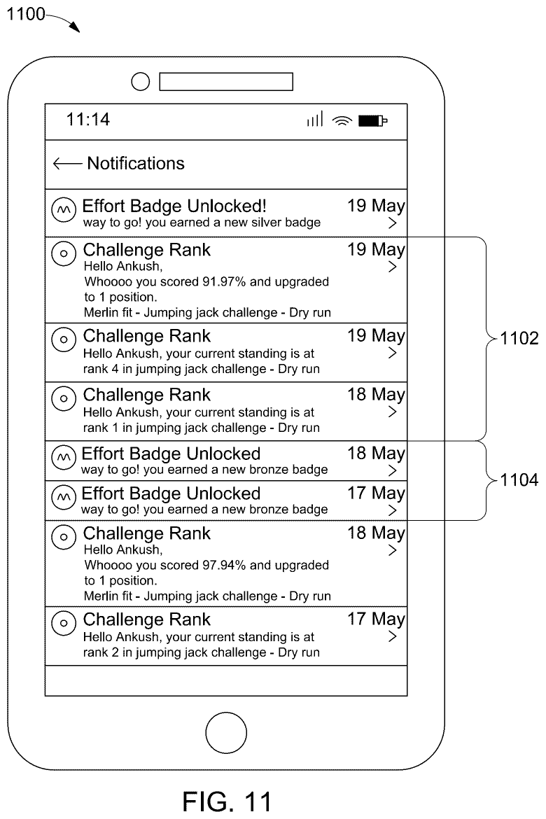

FIG. 11 illustrates an exemplary GUI 1100 rendering a list of notifications, in accordance with an embodiment of the present disclosure. The list of notifications may include provides one or more notifications including, but not limited to, rank change notifications 1102 based on determination of change in individual ranking. Further, list of notifications provides one or more notifications including, but not limited to a group rank change notification 1102 based on the determined change the individual ranking. Further, a list of notifications provides one or more notifications including, but not limited to, individual achievement badges and group achievement badges 1104 associated with the at least one milestone or group milestone respectively.

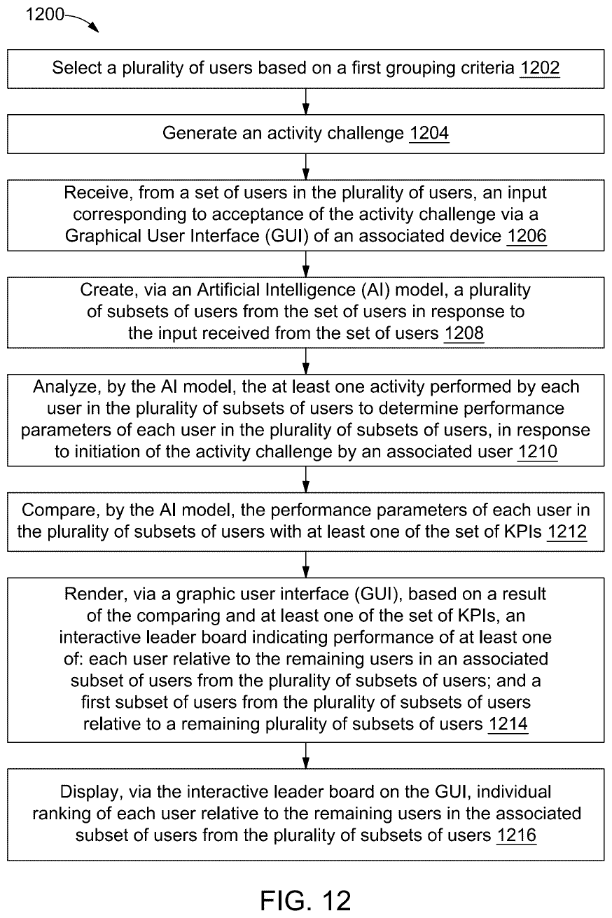

Referring now to FIG. 12, a flowchart of a method 1200 for providing an AI assisted activity training is illustrated, in accordance with some embodiments. The method 1200 may include selecting a plurality of users based on a first grouping criteria at step 1202. Further, the method 1200 may include generating an activity challenge at step 1204. The activity challenge may be associated with at least one activity and a set of Key Performance Indicators (KPIs). Further, the method 1200 may include receiving from a set of users in the plurality of users, an input corresponding to acceptance of the activity challenge via a Graphical User Interface (GUI) of an associated device at step 1206. Further, the method 1200 may include creating, via an Artificial Intelligence (AI) model, a plurality of subsets of users from the set of users in response to the input received from the set of users at step 1208. The plurality of subsets of users may be created based on at least one of: attributes of each of the set of users, and the set of KPIs associated with the activity challenge. The method 1200 may further include analyzing, by the AI model, the at least one activity performed by each user in the plurality of subsets of users to determine performance parameters of each user in the plurality of subsets of users, in response to initiation of the activity challenge by an associated user at step 1210. The method 1200 may further include comparing, by the AI model, the performance parameters of each user in the plurality of subsets of users with at least one of the set of KPIs at step 1212. The method 1200 may further include rendering, via a graphic user interface (GUI), based on a result of the comparing and at least one of the set of KPIs, an interactive leader board indicating performance of at least one of: each user relative to the remaining users in an associated subset of users from the plurality of subsets of users; and a first subset of users from the plurality of subsets of users relative to a remaining plurality of subsets of users at step 1214. Further, the method 1200 may include displaying, via the interactive leader board on the GUI, individual ranking of each user relative to the remaining users in the associated subset of users from the plurality of subsets of users at step 1216.

As will be appreciated by those skilled in the art, the techniques described in the various embodiments discussed above are not routine, or conventional, or well understood in the art. The techniques discussed above allow the users to be active by performing the activity challenges and compete with other users.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of monitoring user activities, the method comprising:
selecting a plurality of users based on a first grouping criteria;
generating an activity challenge, wherein the activity challenge is associated with at least one activity and a set of Key Performance Indicators (KPIs);
receiving, from a set of users in the plurality of users, an input corresponding to acceptance of the activity challenge via a Graphical User Interface (GUI) of an associated device;
creating, via an Artificial Intelligence (AI) model, a plurality of subsets of users from the set of users in response to the input received from the set of users, wherein the plurality of subsets of users are created based on at least one of:
attributes of each of the set of users, and
the set of KPIs associated with the activity challenge;
analyzing, by the AI model, the at least one activity performed by each user in the plurality of subsets of users to determine performance parameters of each user in the plurality of subsets of users, in response to initiation of the activity challenge by an associated user;
comparing, by the AI model, the performance parameters of each user in the plurality of subsets of users with at least one of the set of KPIs; and
rendering, via a graphic user interface (GUI), based on a result of the comparing and at least one of the set of KPIs, an interactive leader board indicating performance of at least one of:
each user relative to the remaining users in an associated subset of users from the plurality of subsets of users; and
a first subset of users from the plurality of subsets of users relative to a remaining plurality of subsets of users.

2. The method of claim 1, comprises:
capturing, via at least one multimedia input device, a real-time video of the at least one activity performed by each user in the plurality of subsets of users, wherein the analyzing is performed contemporaneous to the capturing.

3. The method of claim 1, wherein the analyzing comprises:
determining, by the AI model, a pose skeleton model based on determination of joints of each user in the plurality of subsets of users in the captured real-time video.

4. The method of claim 3, comprises:
overlaying, by the AI model, the captured real-time video of each user in the plurality of subsets of users with the pose skeletal model; and
generating, by the AI model, feedback for each user in the plurality of subsets of users based on the result of the comparing and the pose skeletal model.

5. The method of claim 4, wherein the feedback comprises at least one of corrective actions or alerts generated as at least one of visual feedback, aural feedback, or haptic feedback.

6. The method of claim 1, wherein the set of KPIs comprises a predefined duration of the activity challenge, a predefined sub-duration of the activity challenge, a number of sets of the at least one activity, a number of repetitions of the at least one activity in each set of the at least one activity, a target number of calories, a target accuracy level of the at least one activity, and a duration of rest time between consecutive sets of the at least one activity.

7. The method of claim 6, wherein the rendering comprises, displaying, via the interactive leader board on the GUI, individual ranking of each user relative to the remaining users in the associated subset of users from the plurality of subsets of users.

8. The method of claim 7, further comprising:
identifying a change in the performance of a user relative to the remaining users in the associated subset after an instance of the performance of the at least one activity;
determining a change in the individual ranking of the user relative to the remaining users in the associated subset of users based on the change in performance; and
rendering, by the GUI, a rank change notification based on the determined change in the individual ranking.

9. The method of claim 8, wherein determining the change in the individual ranking of the user comprises computing at least one of:
a number of instances of the performance of the at least one activity by the user during the predefined duration of the activity challenge;
the maximum number of sets of the at least one activity performed by the user during the predefined duration of the activity challenge;
the maximum number of repetitions of the at least one activity performed by the user during the predefined duration of the activity challenge;
the maximum number of repetitions of the at least one activity performed by the user with the target accuracy level during the predefined duration of the activity challenge;
the maximum number of sets of the at least one activity performed by the user during the predefined sub-durations of the activity challenge; and
the maximum number of repetitions of the at least one activity performed by the user during the predefined sub-durations of the activity challenge.

10. The method of claim 9, further comprising:
determining, by the AI model, achievement of at least one milestone from a plurality of predefined milestones, based on a result of the computing; and
identifying a reward badge associated with the at least one milestone achieved by the user.

11. The method of claim 6, wherein the rendering comprises, displaying, via the interactive leader board on the GUI, group ranking of the first subset of users from the plurality of subsets of users relative to each of the remaining plurality of subsets of users.

12. The method of claim 11, further comprising:
identifying a change in performance of the first subset of users from the plurality of subsets of users relative to each of the remaining plurality of subsets of users after an instance of the performance of the at least one activity;
determining a change in the group ranking of the first subset of users from the plurality of subsets of users relative to each of the remaining plurality of subsets of users based on the change in performance; and
rendering, by the GUI, a group rank change notification based on the determined change the individual ranking.

13. The method of claim 12, wherein determining the change in the group ranking of the first subset of users comprises computing at least one of:
a number of instances of the performance of the at least one activity by the first subset of users during the predefined duration of the activity challenge;
the maximum number of sets of the at least one activity performed by the first subset of users during the predefined duration of the activity challenge,
the maximum number of repetitions of the at least one activity performed by the first subset of users during the predefined duration of the activity challenge;
the maximum number of repetitions of the at least one activity performed by the first subset of users with the target accuracy level during the predefined duration of the activity challenge;
the maximum number of sets of the at least one activity performed by the first subset of users during the predefined sub-durations of the activity challenge; and
the maximum number of repetitions of the at least one activity performed by the first subset of users during the predefined sub-durations of the activity challenge.

14. The method of claim 1, further comprising:
determining, by the AI model, a cumulative group performance of the first subset of users by cumulating the determined performance parameters of all users in the first subset of users in response to each instance of initiation of the activity challenge by the first subset of users during the predefined duration of the activity challenge; and
rendering, by the GUI, a group progress report of the first subset of users from the plurality of subsets of users relative to each of the remaining plurality of subsets of users based on the determined cumulative group performance.

15. The method of claim 14, further comprising:
determining, by the AI model, achievement of at least one group milestone from a plurality of group milestones by each of the first subset of users from the plurality of subsets of users based on a comparison of the cumulative group performance with a corresponding predefined threshold associated with each of the plurality of group milestones; and
displaying, by the GUI, a group achievement badge associated with the at least one group milestone in the group progress report of the first subset of users from the plurality of subsets of users.

16. The method of claim 1, further comprising:
creating, by the AI model, a plurality of groups of users from the associated subset of users based on a second grouping criteria;
generating a sub-activity challenge corresponding to the activity challenge, wherein the sub-activity challenge is associated with at least one sub-activity of the at least one activity and a subset of KPIs;
analyzing, by the AI model, the at least one sub-activity performed by each user in the plurality of groups of users to determine sub-activity performance parameters of each user in the plurality of groups of users in response to performance of the sub-activity challenge by the corresponding user;
comparing, by the AI model, the sub-activity performance parameters of each user in the plurality of groups of users with at least one of the subset of KPIs; and
rendering, via the GUI, based on a result of the comparing and the at least one of the subset of KPIs, the interactive leader board indicating performance of at least one of:
each user relative to the remaining users in an associated group from the plurality of groups of users; and
a group of users from the plurality of groups of users relative to a remaining groups of users.

17. The method of claim 16, wherein the second grouping criteria comprises:
a manual input received from one of the associated subset of users,
one or more common attributes determined for the associated subset of users, and
one or more common performance parameters determined based on the result of the comparing and the subset of KPIs.

18. The method of claim 1, wherein the first grouping criteria comprises:
a manual input received from one of the plurality of users for selecting the plurality of users, and
one or more common attributes determined for the plurality of users.

19. A system for monitoring user activities, the system comprising:
a processor; and
a memory communicatively coupled to the processor, wherein the memory stores processor-executable instructions, which, on execution, causes the processor to:
select a plurality of users based on a first grouping criteria;
generate an activity challenge, wherein the activity challenge is associated with at least one activity and a set of Key Performance Indicators (KPIs);
receive, from a set of users in the plurality of users, an input corresponding to acceptance of the activity challenge via a Graphical User Interface (GUI) of an associated device;
create, via an Artificial Intelligence (AI) model, a plurality of subsets of users from the set of users in response to the input received from the set of users, wherein the plurality of subsets of users are created based on at least one of:
attributes of each of the set of users, and
the set of KPIs associated with the activity challenge;
analyze, by the AI model, the at least one activity performed by each user in the plurality of subsets of users to determine performance parameters of each user in the plurality of subsets of users, in response to initiation of the activity challenge by an associated user;
compare, by the AI model, the performance parameters of each user in the plurality of subsets of users with at least one of the set of KPIs; and
render, via a graphic user interface (GUI), based on a result of the comparing and at least one of the set of KPIs, an interactive leader board indicating performance of at least one of:
each user relative to the remaining users in an associated subset of users from the plurality of subsets of users; and
a first subset of users from the plurality of subsets of users relative to a remaining plurality of subsets of users.

20. The system of claim 19, wherein to analyze the at least one activity, the processor-executable instructions, upon execution, cause the processor to:
determine, by the AI model, a pose skeleton model based on determination of joints of each user in the plurality of subsets of users in the captured real-time video.

21. The system of claim 19, wherein the set of KPIs comprises a predefined duration of the activity challenge, predefined sub-durations of the activity challenge, a number of sets of the at least one activity, a number of repetitions of the at least one activity in each set of the at least one activity, a target number of calories, a target accuracy level of the at least one activity, and a duration of rest time between consecutive sets of the at least one activity.

22. The system of claim 19, wherein to render the interactive leader board, the processor-executable instructions, upon execution, further cause the processor to:
display, via the interactive leader board on the GUI, individual ranking of each user relative to the remaining users in the associated subset of users from the plurality of subsets of users.

23. The system of claim 22, wherein the processor-executable instructions, upon execution, further cause the processor to:
identify, by the AI model, a change in performance of the first subset of users from the plurality of subsets of users relative to each of the remaining plurality of subsets of users after an instance of the performance of the at least one activity;
determine, by the AI model, a change in the group ranking of the first subset of users from the plurality of subsets of users relative to each of the remaining plurality of subsets of users based on the change in performance; and
render, by the GUI, a group rank change notification based on the determined change the individual ranking.

24. The system of claim 23, wherein to determining the change in the group ranking of the first subset of users, the processor-executable instructions, upon execution, cause the processor to compute at least one of:
a number of instances of the performance of the at least one activity by the first subset of users during the predefined duration of the activity challenge;
the maximum number of sets of the at least one activity performed by the first subset of users during the predefined duration of the activity challenge,
the maximum number of repetitions of the at least one activity performed by the first subset of users during the predefined duration of the activity challenge;
the maximum number of repetitions of the at least one activity performed by the first subset of users with the target accuracy level during the predefined duration of the activity challenge;
the maximum number of sets of the at least one activity performed by the first subset of users during the predefined sub-durations of the activity challenge; and
the maximum number of repetitions of the at least one activity performed by the first subset of users during the predefined sub-durations of the activity challenge.

25. The system of claim 19, wherein the processor-executable instructions, upon execution, further cause the processor to:
determine, by the AI model, a cumulative group performance of the first subset of users by cumulating the determined performance parameters of all users in the first subset of users in response to each instance of initiation of the activity challenge by the first subset of users during the predefined duration of the activity challenge; and
render, by the GUI, a group progress report of the first subset of users from the plurality of subsets of users relative to each of the remaining plurality of subsets of users based on the determined cumulative group performance.

26. The system of claim 25, wherein the processor-executable instructions, upon execution, further cause the processor to:
determine, by the AI model, achievement of at least one group milestone from a plurality of group milestones by each of the first subset of users from the plurality of subsets of users based on a comparison of the cumulative group performance with a corresponding predefined threshold associated with each of the plurality of group milestones; and
display, by the GUI, a group achievement badge associated with the at least one group milestone in the group progress report of the first subset of users from the plurality of subsets of users.

27. The system of claim 19, wherein the processor-executable instructions, upon execution, further cause the processor to:
create, by the AI model, a plurality of groups of users from the associated subset of users based on a second grouping criteria;
generate a sub-activity challenge corresponding to the activity challenge, wherein the sub-activity challenge is associated with at least one sub-activity of the at least one activity and a subset of KPIs;
analyze, by the AI model, the at least one sub-activity performed by each user in the plurality of groups of users to determine sub-activity performance parameters of each user in the plurality of groups of users in response to performance of the sub-activity challenge by the corresponding user;
compare, by the AI model, the sub-activity performance parameters of each user in the plurality of groups of users with at least one of the subset of KPIs; and
render, via the GUI, based on a result of the comparing and the at least one of the subset of KPIs, the interactive leader board indicating performance of at least one of:
each user relative to the remaining users in an associated group from the plurality of groups of users; and
a group of users from the plurality of groups of users relative to a remaining groups of users.

28. A device for monitoring user activities, comprising:
a processor;
a Graphical User Interface (GUI); and
a memory communicatively coupled to the processor, wherein the memory stores processor-executable instructions, which, on execution, causes the processor to:
receive an input from a user corresponding to acceptance of an activity challenge via the GUI,
wherein the activity challenge is associated with at least one activity and a set of Key Performance Indicators (KPIs), and
wherein based on the input, the user is added to at least one of a plurality of subsets of users from a set of users based on:
attributes of each of the set of users, and
the set of KPIs associated with the activity challenge;
determine performance parameters of the user based on analysis of the at least one activity performed by the user and remaining users in an associated subset of users from the plurality of subsets of users in response to initiation of the activity challenge by the user and the remaining users,
render on the GUI, an interactive leader board indicating performance of at least one of:
the user relative to the remaining users in the associated subset of users from the plurality of subsets of users; and
a first subset of users to which the user is associated from the plurality of subsets of users relative to a remaining plurality of subsets of users,
wherein the interactive leader board is rendered based on a result of comparison of performance parameters each user in the plurality of subsets of users with at least one of the set of KPIs.
